(19) United States
(12) Patent Application Publication
(10) Pub. No.: US 2013/0044104 A1
(43) Pub. Date: Feb. 21, 2013

(54) Methods and Apparatus for Displaying an Image with Enhanced Depth Effect

(71) Applicant: Jaison Bouie, Houston, TX (US)

(72) Inventor: Jaison Bouie, Houston, TX (US)

(21) Appl. No.: 13/582,985

(22) PCT Filed: Jan. 22, 2008
(86) PCT No.: PCT/US08/51597

§ 371 Date: Sep. 5, 2012

(51) Int. Cl. G06T 15/00

(52) U.S. Cl. 345/419

(57) ABSTRACT

Methods and apparatus for displaying an image with enhanced image depth arc disclosed. In one method, a range of depth values of picture elements (pixels) of an image is divided into multiple depth layers, and pixels in the different depth layers are displayed in a phased manner relative to the frame start time. For each image frame, objects with increasing depth in a scene arc displayed with increasing delays relative to the image frame start time. The resulting illusion of depth is believed to be attributable to the edge-detection response of the human visual system. which reacts strongly to the alternating illumination on each side of an object's edge. In some implementations, the display device includes multiple pixel units that arc individually activated dependent upon corresponding pixel depth data.

### BACKGROUND

Depth perception is the visual ability to perceive the world in three dimensions, and provides an observer the ability to accurately gauge distances to objects and displacements between objects. In many higher animals, depth perception relies heavily on binocular vision, but also uses many monocular cues to form the final integrated perception. Human beings have two eyes separated by about 2.5 inches. Light rays entering each eye are brought to focus on the retina. Photoreceptor nerve cells in the retina respond to the presence and intensity of the light rays by producing electrical impulses which are transmitted to the brain. Each eye has a slightly different viewpoint, and sends impulses conveying a slightly different two-dimensional image to the brain. The brain fuses the two different two-dimensional images together, resulting in a single image with apparent depth. The brain uses differences in the two-dimensional images from the eyes to interpret depth, thereby producing three-dimensional or stereoscopic vision.

Conventional three-dimensional (3D) display techniques provide each of an observer's eyes with a slightly different image. The observer's brain then uses the differences in the images to produce a single image with apparent depth. Known 3D display techniques rely on polarized light, different colors (anaglyph), alternating columns (lenticular lens), alternating images (shuttering), separate displays, or volumetric constructions.

All of the known 3D display techniques require special apparatus for providing each of an observer's eyes with a slightly different image. For example, in known polarized light techniques, the observer wears glasses with polarized lenses that allow only a left eye image to enter the left eye, and only a right eye image to enter the right eye. Similarly, known different-color (anaglyph) techniques require that the observer wear glasses with a different colored lens for each eye (e.g., one red lens and one green lens). The different colored lenses allow only a left eye image to enter the left eye, and only a right eye image to enter the right eye. Known alternating-column (lenticular lens) techniques include special optics that allow only a left eye image to be visible to an observer's left eye, and only a right eye image to be visible to the observer's right eye.

### SUMMARY

The problems identified above are at least partly addressed by herein described display methods and apparatus for enhancing a viewer's perception of depth. In contrast to known 3D techniques, the disclosed methods and apparatus do not require that each of an observer's eyes be provided with a slightly different image. Rather, a display screen presents different portions of an image in a phased manner that enhances the viewer's perception of depth. For each image frame, objects with increasing depth in a scene are displayed with increasing delays relative to the image frame start time. The resulting illusion of depth is believed to be attributable to the edge-detection response of the human visual system, which reacts strongly to the alternating illumination on each side of an object's edge.

Some disclosed method embodiments for displaying an image containing multiple objects include: displaying multiple portions of the image alternately and in timed sequence such that periods of time between consecutive displays of the portions fall within a selected range of time. Each of the multiple portions of the image contains a different one of the objects, and the range of time is selected such that a human observer of the image perceives depth in the image as the portions of the image are displayed. The image may be made up of multiple picture elements (pixels) having associated depth values. The display method may include dividing the pixels into multiple depth layers, including at least a first depth layer and a second depth layer. The pixels having depth values within the first depth layer are displayed at a start time, and after a selected period of time from the start time, the pixels having depth values within the second layer are displayed. The selected period of time is selected such that a human observer of the image perceives depth in the image as the pixels of the image are displayed.

Some system implementations include a display device having a display screen, and a memory system storing color/intensity data and depth data for each of multiple pixels of an image to be displayed on the display screen. The image is divided into multiple depth layers. A display processor of the display system is coupled between the memory system and the display device, and is configured to access the color/intensity data and the depth data stored in the memory system, to use the color/intensity data and the depth data to generate a display signal, and to provide the display signal to the display device. The display signal causes the display device to display the depth layers of the image on the display screen alternately and in timed sequence such that a human observer of the image preceives depth in the image.

Some display device embodiments include multiple pixel units, wherein each of the pixel units includes: a pixel cell configured to display a pixel dependent upon color/intensity data of the pixel, a color/intensity data buffer for storing the color/intensity data, a depth data buffer for storing depth data of the pixel, a pixel switch element coupled to the color/intensity data buffer, and a timing circuit coupled to the depth data buffer and to the pixel switch element. The pixel switch element is coupled to receive a signal from the timing circuit, and configured to provide the color/intensity data from the color/intensity data buffer to the pixel cell in response to the signal from the timing circuit. The timing circuit is configured to provide the signal to the pixel switch element dependent upon the depth data stored in the depth data buffer.

### BRIEF DESCRIPTION OF THE DRAWINGS

A better understanding of the various disclosed embodiments can be obtained when the detailed description is considered in conjunction with the following drawings, in which:

FIG. 1 is a diagram of an image to be displayed on a display screen, wherein the image includes several different objects;

FIG. 2 is a diagram of a first portion of the image of FIG. 1 being displayed on the display screen;

FIG. 3 is a diagram of a second portion of the image of FIG. 1 being displayed on the display screen;

FIG. 4 is a diagram of a third portion of the image of FIG. 1 being displayed on the display screen;

FIG. 5 is a timing diagram for a method for displaying the image of FIG. 1 on the display screen so as to provide a human observer with a perception of depth in the image;

FIG. 6 is a diagram of a three-dimensional space defined for picture elements (pixels) making up the image of FIG. 1;

FIG. 7 is a flow chart of a method for displaying an image such that an observer of the image perceives depth in the image;

FIG. 8 is a diagram of one embodiment of a three-dimensional space defined for pixels making up the image displayed by the method of FIG. 7;

FIG. 9 is a timing diagram for the method of FIG. 7;

FIG. 10 is a diagram of one embodiment of a display system for displaying an image such that an observer of the image perceives depth in the image;

FIG. 11 is a diagram of one embodiment of a display device of the display system of FIG. 10. wherein the display device includes multiple pixel units that are individually activated dependent upon corresponding pixel depth data; and

FIG. 12 is a diagram of a representative one of the pixel units of the display device of FIG. 11.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

FIGS. 1-4 will be used to illustrate one embodiment of a method for displaying an image such that a human observer of the image perceives depth in the image. FIG. 1 is a diagram of an image 10 to be displayed on a display screen, wherein the image 10 includes several different objects: a chair 14, a potted plant 16, a floor 18, a picture 20, and a wall 22. The objects in the image 10 are positioned about each other in three-dimensional space. The chair 14 and the potted plant 16 are resting on the floor 18, and the picture 20 is hanging on the wall 22. The chair 14 is closest to an observer of the image 10, and farthest from the wall 22. The plant 16 is farther from the observer than the chair 14, and closer to the wall 22 than the chair 14.

In the image 10 of FIG. 1, a portion of the plant 16 is located behind the chair 14, and that portion of the plant 16 is not visible in the image 10. Similarly, portions of the floor 18 and the wall 22 are located under and behind the chair 14 and the plant 16 and are not visible in image 10.

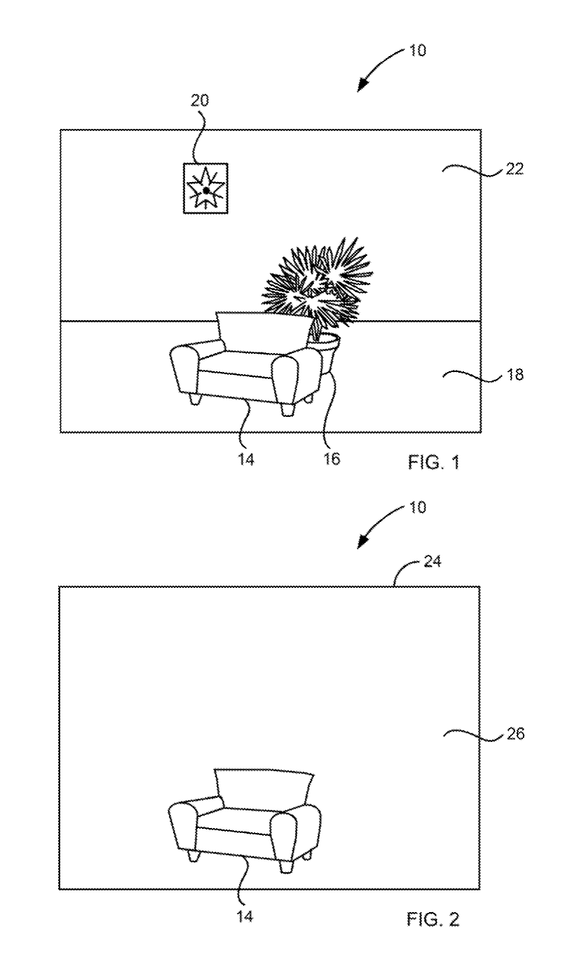

FIGS. 2-4 illustrate how portions of the image 10 of FIG. 1 may be displayed on the display screen alternately and in timed sequence such that the observer perceives depth in the image 10. FIG. 2 is a diagram of a first portion of the image 10 of FIG. 1 being displayed on a display screen 24. The first portion of the image 10 includes the chair 14 by itself. A portion 26 of the image 10 surrounding the chair 14 is preferably a selected fill color. The selected fill color is preferably black as a black fill color induces the least amount of activation in photoreceptors of the observer's eyes. The fill color may also serve to create artificial discontinuities or “edges” about the chair 14. thereby enhancing an edge detection response in the visual processing center of the observer's brain. The display screen 24 may be or may include a liquid crystal display (LCD) screen, or a portion of a cathode ray tube (CRT).

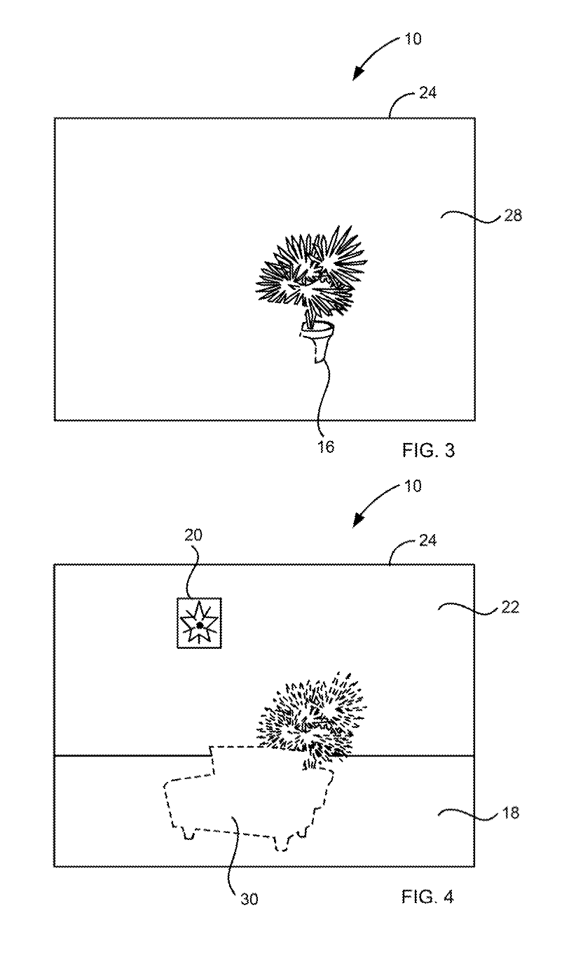

A selected period of time after the first portion of the image 10 is displayed, a second portion of the image 10 is displayed. FIG. 3 is a diagram of a second portion of the image 10 of FIG. 1 being displayed on the display screen 24. The second portion of the image 10 includes a visible portion of the plant 16 by itself. A portion 28 of the image 10 surrounding the visible portion of the plant 16 is preferably the selected color for the reasons described above.

A selected period of time after the second portion of the image 10 is displayed, a third portion of the image 10 is displayed. FIG. 4 is a diagram of a third portion of the image 10 of FIG. 1 being displayed on the display screen 24. The third portion of the image 10 includes the floor 18, the picture 20, and the wall 22 by themselves. A portion 30 of the image 10 includes the portions of the image 10 occupied by the chair 14 and the plant 16. The portion 30 is preferably the selected fill color for the reasons described above. A selected period of time after the third portion of the image 10 is displayed, the cycle of displaying the different portions of the image 10 alternately and in timed sequence is repeated, and the first portion of the image 10 shown in FIG. 2 is again displayed.

As described in more detail below, the selected periods of time between the displays of the portions of the image 10 are generally selected such that the observer has time to “see” one portion of the image 10 before another portion of the image 10 is displayed. As a result of displaying the portions alternately and in timed sequence, the observer perceives depth in the image 10. It is believed that this perception of depth is due to an interaction between the activation of visual receptors in the eyes and the visual processing center of the human brain, wherein the human brain processes the temporal discrepancies in the displayed portions of the image 10 as depth.

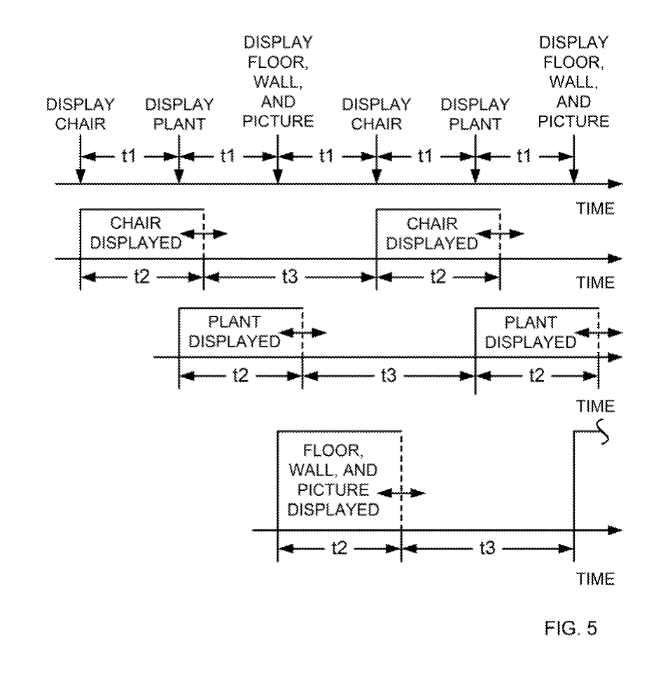

FIG. 5 is a timing diagram for the above described method for displaying the image 10 of FIG. 1 on the display screen so as to provide the observer with a perception of depth in the image 10. As indicated in FIG. 5, the chair 14 is first displayed. (See FIG. 2 and the above description of FIG. 2.) A time period after the chair 14 is displayed, the visible portion of the plant 16 is displayed. (See FIG. 3 and the above description of FIG. 3.) A time period ‘t1’ after the visible portion of the plant 16 is displayed, the floor 18, the picture 20, and the wall 22 are displayed. (See FIG. 4 and the above description of FIG. 4.) A time period ‘t1’ after the floor 18, the picture 20, and the wall 22 are displayed, the cycle of displaying the portions of the image 10 alternately and in timed sequence is repeated as described above.

As described above, the time period ‘t1’ between the displays of the portions of the image 10 is generally selected such that the observer has time to “see” one portion of the image 10 before another portion of the image 10 is displayed. In general, the time period ‘t1’ is about 1/60th of a second (0.0167 sec.) as it is believed that the human eye has a natural frequency of 60 hertz (Hz). The time period ‘t1’ between displays preferably ranges from about 11 milliseconds (0.011 seconds) to approximately 17 milliseconds (0.017 seconds).

In the embodiment of FIG. 5, each portion of the image 10 of FIG. 1 is displayed for a time period ‘t2’ followed by a time period ‘t3’ during which the portion of the image 10 is not displayed. As indicated in FIG. 5, the time periods ‘t2’ and ‘t3’ may be varied to achieve desired qualities of the displayed image 10, such as image brightness. As the time period ‘t2’ is increased, the time period ‘t3’ decreases. In addition, the time periods ‘t2’ and ‘t3’ may vary as a function of image intensity or spatial position. Assuming a 60 Hz (cycles per second) refresh rate with display for 9 cycles and non-display for 1 cycle, exemplary values for the time periods ‘t2’ and ‘t3’ are 0.1500 seconds and 0.0167 seconds, respectively. It is noted that the refresh rate, the number of cycles that a portion of an image is displayed, and the number of cycles that the portion of the image is not displayed are all variable.

Also evident in FIG. 5 is that fact that the displays of the portions of the image 10 of FIG. 1 may overlap. In FIG. 5, the display of the second portion of the image 10, including the visible portion of the plant 16 (see FIG. 3), begins before the display of the first portion of the image 10, including the chair 14 (see FIG. 2), ends. Thus for a period of time the chair 14 and the visible portion of the plant 16 may be displayed on the display screen 24 simultaneously. Similarly, during the display of the second portion of the image 10, including the visible portion of the plant 16, the display of the third portion of the image 10, including the floor 18, the picture 20, and the wall 22, is initiated. Thus for a period of time the visible portion of the plant 16, the floor 18, the picture 20, and the wall 22 are displayed simultaneously. It is also possible that the time period ‘t2’ is less than the time period ‘t1’ such that the displays of the portions of the image 10 of FIG. 1 do not overlap.

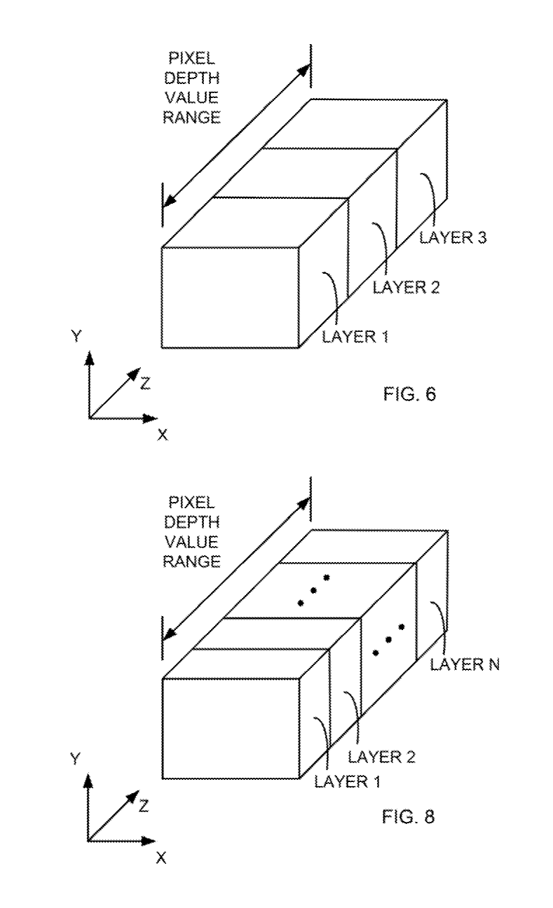

FIG. 6 is a diagram of a three-dimensional space defined for pixels making up the image 10 of FIG. 1. Each pixel has an ‘X’ value representing a distance along an indicated ‘X’ axis and a ‘Y’ value representing a distance along an indicated ‘Y’ axis. In general, the ‘X’ and ‘Y’ values correspond to a specific location or the pixel on the display screen 24 (sec FIGS. 2-4). Each pixel also has a ‘Z’ value representing a distance along an indicated ‘Z’ axis that is orthogonal to a plane defined by the ‘X’ and ‘Y’ axes. The ‘Z’ value represents a distance of the pixel from the plane defined by the ‘X’ and ‘Y’ axes; that is, a depth of the pixel within the three-dimensional space relative to the display screen 24.

In general, the ‘X,’ ‘Y,’ and ‘Z’ values of the pixels making up the image 10 of FIG. 1 vary over predetermined ranges. The ‘Z’ values of the pixels vary within a depth value range as indicated in FIG. 6. In FIG. 6, the depth value range is divided into three sections or layers: a layer 1, a layer 2, and a layer 3. The portion of the image 10 including the chair 14 (see FIG. 2) may include pixels having depth values within the layer 1. The portion of the image 10 including the visible part of the plant 16 (see FIG. 3) may include pixels having depth values within the layer 2, and the portion of the image 10 including the floor 18, the picture 20, and the wall 22 may include pixels having depth values within the layer 3.

For example, the image 10 may be a computer-generated image, generated in such a way that the pixels forming the chair 14 (see FIG. 2) have depth values within the layer 1, the pixels forming the visible part of the plant 16 (see FIG. 3) have depth values within the layer 2, and the pixels forming the floor 18, the picture 20, and the wall 22 have depth values within the layer 3.

Referring back to FIGS. 1-5, the portions of the image 10 may be displayed on the display screen 24 such that pixels having depth values within the layer 1 are first activated. As a result, the first portion of the image 10 including the chair 14 is first displayed. (See FIG. 2.) The time period ‘t1’ after the pixels having depth values within the layer 1 are activated, pixels having depth values within the layer 2 may be activated. As a result, the second portion of the image 10 including the visible portion of the plant 16 is displayed. (See FIG. 3.) The time period ‘t1’ after the pixels having depth values within the layer 2 are activated, pixels having depth values within the layer 3 may be activated. Accordingly, the third portion of the image 10 including the floor 18, the picture 20, and the wall 22 is displayed. (See FIG. 4.) The time period ‘t1’ after the pixels having depth values within the layer 3 are activated, the cycle of activating the pixels having depth values within the three depth layers is repeated. As the pixels of the image 10 are triggered in this manner. the observer of the image 10 expectedly has a perception of depth in the image 10.

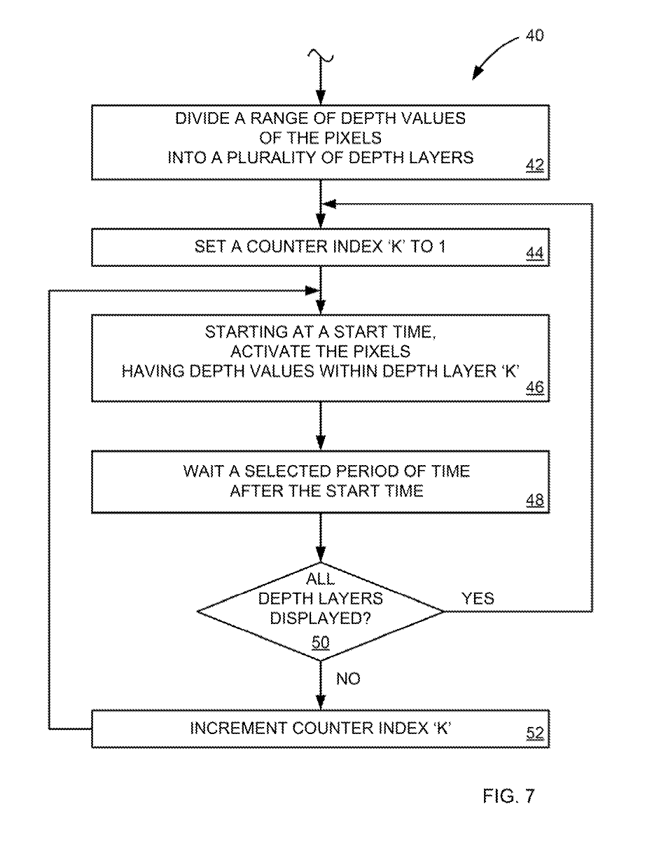

FIG. 7 is a flow chart of a method 40 for displaying an image such that an observer of the image perceives depth in the image. During a first step 42 of the method 40, a range of depth values of the pixels is divided into a plurality of depth layers. FIG. 8 is a diagram of one embodiment of a three-dimensional space defined for pixels making up the image displayed by the method 40 of FIG. 7. As indicated in FIG. 8, the ‘Z’ values of the pixels vary within a predefined depth value range, wherein the depth value range is divided into sections or layers. Three of the n layers, a layer 1, a layer 2, and a layer n, are shown in FIG. 8.

Referring back to FIG. 7, a counter index ‘k’ is set to 1 during a step 44. During a step 46, pixels having depth values within the depth layer k are displayed beginning at a start time. A step 48 involves waiting a selected period of time after the start time. During a decision step 50, a decision is made as to whether all of the n depth layers have been displayed. If all of the n depth layers have been displayed, the step 44 is repeated. If all of the n depth layers have not been displayed during the decision step 50, the counter index k is incremented during a step 52, and the step 46 is repeated.

During the method 40, the depth layers may he displayed on a display screen. The display screen may be or may include a liquid crystal display (LCD) screen, or a portion of a cathode ray tube (CRT). In general, pixels that are activated produce light (e.g., according to corresponding color/intensity data), and pixels that are not activated do not produce light.

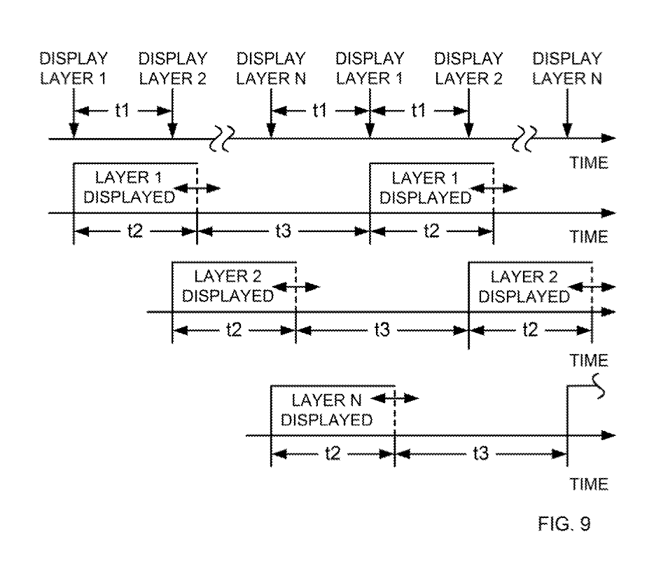

FIG. 9 is a timing diagram for the method 40 of FIG. 7. In FIG. 9, the selected period of time is the time period ‘t1’ described above. As the method 40 is carried out, the image is displayed such that pixels having depth values within the layer 1 are first displayed (see FIG. 8). As a result, a first portion of the image is displayed, wherein the first portion of the image preferably includes a first object. The time period ‘t1’ after the pixels having depth values within the layer 1 are displayed, pixels having depth values within the layer 2 are displayed (see FIG. 8). As a result, a second portion of the image is displayed, wherein the second portion of the image preferably includes a second object. This process continues until the pixels having depth values within the layer n are displayed (see FIG. 8). Following the display of the pixels having depth values within the layer n, the pixels having depth values within the layer 1 are displayed again as the cycle repeats. As the pixels of the image are displayed in this manner, the observer of the image expectedly perceives depth in the image.

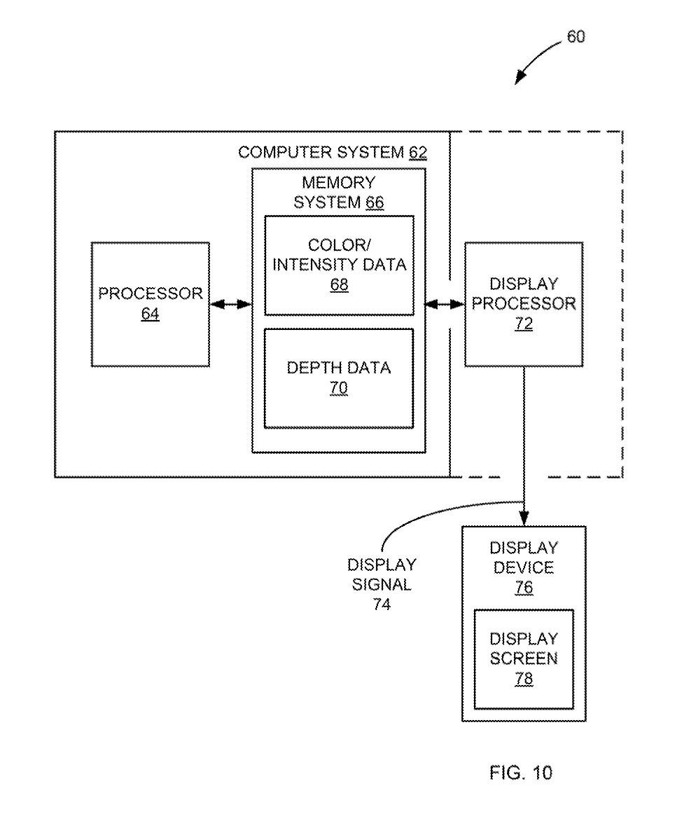

FIG. 10 is a diagram of one embodiment of a display system 60 for displaying an image such that an observer of the image perceives depth in the image. The image may, for example, include multiple objects (see FIG. 1). In the embodiment of FIG. 10, the system 60 includes a computer system 62, a display processor 72, and a display device 76 including a display screen 78. The computer system 62 includes a processor 64 coupled to a memory system 66. In general, the processor 64 generates color/intensity data 68 and depth data 70 for each of multiple pixels of an image to be displayed on the display screen 78 of the display device 76, and stores the color/intensity data 68 and the depth data 70 in the memory system 66.

In general, the display processor 72 is coupled to the memory system 66 of the computer system 62, and accesses the color/intensity data 68 and the depth data 70 stored in the memory system 66. The display processor 72 uses the color/intensity data 68 and the depth data 70 retrieved from the memory system 66 to generate a display signal 74, and provides the display signal 74 to the display device 76 as indicated in FIG. 10. The display signal 74 may be, for example, a video signal. As indicated in FIG. 10, the display processor 72 may be part of the computer system 62. The display screen 78 may be or may include a liquid crystal display (LCD) screen, or a portion of a cathode ray tube (CRT).

In general, the display signal 74 produced by the display processor 72 causes the display device 76 to display multiple portions of the image alternately and in timed sequence on the display screen 78 such that periods of time between consecutive displays of the portions fall within a selected range of time. Each of the portions of the image preferably contains a different one of multiple objects of the image. As described above, the range of time is selected such that a human observer of the image displayed on the display screen 78 perceives depth in the image as the portions of the image are displayed. The display processor 72 may, for example, carry out the method 40 shown in FIG. 7 and described above.

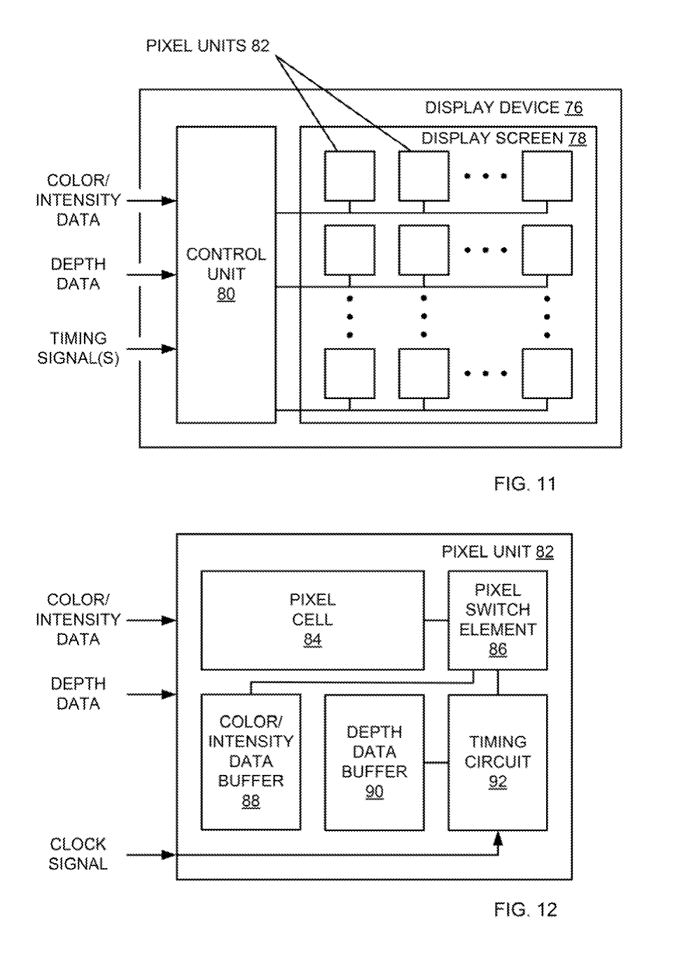

FIG. 11 is a diagram of one embodiment of the display device 76 of FIG. 10 wherein the display device 76 is a liquid crystal display (LCD) with multiple pixel units that are individually activated dependent upon corresponding pixel depth data. In the embodiment of FIG. 11, the display device 76 includes a control unit 80, and the display screen 78 of the display device 76 includes multiple pixel units 82 coupled to the control unit 80. The display signal 74 generated by the display processor 62 (see FIG. 10) and received by the display device 76 includes color/intensity data (from the color/intensity data 68 of FIG. 10), depth data (from the depth data 70 of FIG. 10), and one or more timing signals.

A typical video signal conveys an image made up of a stream of frames, wherein each frame is made up of a series of horizontal lines, and each line is made up of a series of pixels. In a video graphics array (VGA) signal, the lines in each frame are transmitted in order from top to bottom (VGA is not interlaced), and the pixels in each line are transmitted from left to right. Separate horizontal and vertical synchronization signals are used to define the ends of each line and frame, respectively. A “line time” for displaying a line exists between two consecutive horizontal synchronization signals, and a “frame time” for displaying a frame exists between two consecutive vertical synchronization signals.

In general, the control unit 80 uses the one or more timing signals to generate a clock signal, and provides corresponding color/intensity data, corresponding depth data, and the clock signal to each of the pixel units 82. In the method 40 of FIG. 7 described above, a range of depth values of pixels of an image are divided into n layers, and the n layers are displayed alternately in timed sequence. In the embodiment if FIG. 11, the control unit 80 produces the clock signal such that the clock signal has a period that is 1/n times the frame time so that all n layers are displayed during the frame time.

FIG. 12 is a diagram of a representative one of the pixel units 82 of the display device 76 of FIG. 11. In the embodiment of FIG. 12, each pixel unit 82 includes a pixel cell 84, a pixel switch clement 86, a color/intensity data buffer 88, a depth data buffer 90, and a timing circuit 92. The pixel cell 84 is a typical thin film transistor (TFT) light control element; essentially a small capacitor with a liquid crystal material disposed between two optically transparent and electrically conductive layers. The pixel cell 84 is controlled by the pixel switch element 86 and the timing circuit 92.

As described above and indicated in FIG. 12, the control unit 80 (FIG. 11) provides corresponding color/intensity data, corresponding depth data, and the clock signal to the pixel unit 82. When the pixel 82 receives the corresponding color/intensity data and the corresponding depth data, the pixel 82 stores the color/intensity data in the color/intensity data buffer 88, and stores the depth data in the depth data buffer 90.

In one embodiment, the depth data stored in the depth buffer 90 specifies one of n depth layers in which the pixel resides (see FIG. 8). The timing circuit 92 may include, for example, a modulo-n counter that counts from 1 to n during each frame time. When the value of the counter matches the depth data stored in the depth buffer 90, the timing circuit 92 sends a signal to the pixel switch element 86, thereby activating the pixel cell 84. In general, the pixel switch element 86 activates the pixel cell 84 in accordance with the color/intensity data from the color/intensity data buffer 88 in response to the signal from the timing circuit 92. For example, in response to the signal from the timing circuit 92, the pixel switch element 86 may provide the color/intensity data from the color/intensity data buffer 88 to the pixel cell 84. In receiving the color/intensity data from the color/intensity data buffer 88, the pixel cell 84 is activated according to the color/intensity data.

In general, the pixel cell 84 alternates between an active state and an inactive state. Once the pixel cell 84 is activated, the timing circuit 92 determines an amount of time that the pixel cell 84 remains active. At the end of a selected active time period, the timing circuit 92 disables the pixel switch element 86, thereby deactivating the pixel cell 84. The amount of time that the pixel cell 84 remains active is generally selected to achieve a desired level of pixel saturation and hue intensity. The timing circuit 92 may control the amount of time the pixel cell 84 remains active to achieve, for example, a desired active-to-inactive time ratio.

Numerous variations and modifications will become apparent to those skilled in the art once the above disclosure is fully appreciated. For example, it is well known that the human visual system also employs size and intensity cues when evaluating object distances. When such additional visual cues are available, the depth layer sequence may be re-ordered or even reversed without significantly impacting a viewer's perception of depth. It is intended that the following claims be interpreted to embrace all such variations and modifications.

What is claimed is:

1. A method for displaying an image containing objects having different depths within the image, the method comprising:
dividing the image into disjoint portions, each portion containing objects with depths in a respective range; and
displaying disjoint portions of the image in sequence within a frame period.

2. The method of claim 1, wherein the image is one frame of a video, and wherein the method further comprises repeating said dividing and displaying operations for each frame of the video.

3. The method of claim 1, wherein the frame period is in the range from about 0.011 seconds to approximately 0.017 seconds.

4. The method of claim 1, wherein each disjoint portion is displayed for no more than 50% of a frame period.

5. The method of claim 1, wherein the display of disjoint portions adjacent in the sequence partially overlaps in time.

6. The method of claim 1, wherein the sequence orders the disjoint portions in order of increasing depth.

7. The method of claim 1, wherein the sequence orders the disjoint portions in order of decreasing depth.

8. The method as recited in claim 1, wherein the portions of the image are displayed on a screen viewable by multiple viewers.

9. The method as recited in claim 8, wherein the screen comprises a liquid crystal display screen.

10. The method as recited in claim 8, wherein the display screen comprises a portion of a cathode ray tube.

11. A method for displaying an image comprising a plurality of picture elements (pixels), the method comprising:
dividing a range of depth values of the pixels into a plurality of depth layers including a first depth layer and a second depth layer;
activating the pixels having depth values within the first depth layer at a start time;
after a selected period of time from the start time, activating the pixels having depth values within the second depth layer; and
wherein the selected period of time is selected such that a human observer of the image perceives depth in the image as the pixels of the image are displayed.

12. The method as recited in claim 11, wherein the selected period of time ranges from about 0.011 seconds to approximately 0.017 seconds.

13. The method as recited in claim 11, wherein depth values within the first depth layer are less than depth values within the second depth layer.

14. The method as recited in claim 11, wherein depth values within the first depth layer are greater than depth values within the second depth layer.

15. The method as recited in claim 11, wherein the pixels of the image are displayed on a display screen.

16. The method as recited in claim 16, wherein the display screen comprises a liquid crystal display screen.

17. The method as recited in claim 16, wherein the display screen comprises a portion of a cathode ray tube.

18. A display system, comprising:
a display device comprising a display screen;
a memory system storing color/intensity data and depth data for each of a plurality of picture elements (pixels) of an image to be displayed on the display screen, wherein the image comprises a plurality of depth layers;
a display processor coupled between the memory system and the display device and configured to access the color/intensity data and the depth data stored in the memory system, to use the color/intensity data and the depth data to generate a display signal, and to provide the display signal to the display device; and
wherein the display signal causes the display device to display the depth layers of the image on the display screen alternately and in sequence.

19. The display system as recited in claim 18, wherein a period of time between displays of two consecutive depth layers ranges from about 0.011 seconds to approximately 0.017 seconds.

20. The display system as recited in claim 18, further comprising:
a processor coupled to the memory system and configured to generate the color/intensity data and the depth data, and to store the color/intensity data and the depth data in the memory system.

21. The display system as recited in claim 18, wherein the display signal comprises a video signal.

22. A display device, comprising:
a plurality of picture element (pixel) units, wherein each of the pixel units comprises:
a pixel cell configured to display a pixel dependent upon color/intensity data of the pixel;
a color/intensity data buffer for storing the color/intensity data;
a depth data buffer for storing depth data of the pixel;
a pixel switch element coupled to the color/intensity data buffer;
a timing circuit coupled to the depth data buffer and to the pixel switch element;
wherein the pixel switch element is coupled to receive a signal from the timing circuit and configured to activate the pixel cell in accordance with the color/intensity data from the color/intensity data buffer in response to the signal from the timing circuit; and
wherein the timing circuit is configured to provide the signal to the pixel switch element dependent upon the depth data stored in the depth data buffer.

23. The display device as recited in claim 22, wherein the timing circuit is coupled to receive a clock signal, and wherein the timing circuit is configured to provide the signal to the pixel switch element dependent upon the depth data stored in the depth data buffer and the clock signal.

24. The display device as recited in claim 23, wherein the clock signal is derived from a timing signal provided to the display device.

25. The display device as recited in claim 24, wherein the timing signal is a vertical synchronization signal.

26. The display device as recited in claim 23, wherein a timing signal provided to the display device determines a frame time of the display device, and wherein an image to be displayed via the display device is divided into n depth layers, and wherein the clock signal has a period that is 1/n times the frame time such that all n depth layers of the image are displayed during the frame time.

27. The display device as recited in claim 26, wherein the depth data stored in the depth data buffer specifies one of then depth layers in which the pixel resides.

28. The display device as recited in claim 26, wherein the timing circuit comprises a modulo-n counter, and wherein the timing circuit is configured to provide the signal to the pixel switch element when a value of the counter matches the depth data stored in the depth data buffer.

29. The display device as recited in claim 18, wherein the pixel cell alternates between an active state and an inactive state, and wherein the timing circuit determines an amount of time that the pixel cell remains in the active state.

30. The display device as recited in claim 18, wherein the pixel cell comprises a typical thin film transistor (TFT) light control element.
